(19) United States
(12) Patent Application Publication
(10) Pub. No.: US 2009/0037468 A1
(43) Pub. Date: Feb. 5, 2009

(54) METHOD FOR EXAMINING AND REPRESENTING TIMING MARKUP AND RECORDING MEDIUM FOR RECORDING DATA STRUCTURE THEREOF

(75) Inventors: Keng-Jui Hsu, Taipei City (TW); Chi-Lun Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INTERVIDEO, DIGITAL TECH. CORP., Taipei (TW)

(21) Appl. No.: 11/942,731

(22) Filed: Nov. 20, 2007

(30) Foreign Application Priority Data
Jul. 30, 2007 (CN) 200710141358.6

(51) Int. Cl. G06F 17/00; G06F 17/30

(52) U.S. Cl. 707/104.1; 707/E17.009

(57) ABSTRACT

A method for examining and representing a timing markup and a recording medium for recording a data structure thereof are provided. In the examining method, a timing markup including at least one tag is parsed first. Then, a graphic timing markup corresponding to the timing markup is generated according to the property of each tag and the relationship between the tags in the timing markup. The graphic timing markup includes a plurality of nodes corresponding to the tags in the timing markup. Finally, the graphic timing markup is used for executing the examination procedure of the timing markup. As a result, through the help of the graphic timing markup, the efficiency of examining the timing markup is improved, and the convenience of understanding and modifying the timing markup is also increased.

### CROSS-REFERENCE TO RELATED APPLICATION

This application claims the priority benefit of China application serial no. 200710141358.6, filed on Jul. 30, 2007. The entirety of the above-mentioned patent application is hereby incorporated by reference herein and made a part of this specification.

### BACKGROUND OF THE INVENTION

1. Field of the Invention

The present invention relates to a method for examining and representing a timing markup. More particularly, the present invention relates to a method for representing and examining a timing markup by using a graphic timing markup.

2. Description of Related Art

With the ever changing development of science and technology, besides optical disc, video disc and digital video disc (DVD), a high definition DVD (HD DVD) having a larger storage capacity and having features including a mandatory managed copy function and an interactive high definition (HDi) audio-visual playback technology has gradually become a main stream of the new generation optical disc storage medium.

Through the HDi audio-visual playback technology supported by the HD DVD, the menu of the HD DVD becomes more flexible and has a higher interactivity. The manufacturer of the HD DVD may design a directory menu of the optical disc by using a timing markup language having a grammar similar to the synchronized multimedia integration language (SMIL).

However, no detection software can be found in the market for the designer of the optical disc menu to examine the logicality of the compiled timing markup. Although HD DVD Interactivity Jumpstart provided by Microsoft Company can be used to simulate the environment of the HDi application program, only a part of the Java Script is verified during the execution of the interactive process instead of examining the part of the timing markup. Although a US patent titled “Information storage medium, information recording method, and information playback method” has disclosed a method for playback image objects stored in a readable information storage medium, but the menu compiler cannot suspend the execution and check the correctness of the interactive result under a specific time point or interactive behavior when executing a new timing markup. Moreover, a US patent titled “News story markup language and system and process for editing and processing documents” has disclosed a process for processing news story markup language documents, which defines time information of a news story according to limitations provided by the news story markup language. However, the method for finding out a key error quickly if an error or an unexpected interactive result is found during the execution of the timing markup is not provided.

Therefore, most of the optical disc menu compiler can verify whether the timing markup is correct or not only by means of actually executing the interactive process of the directory menu through the HD DVD playback software. If an unexpected interactive result is found during the verification, the menu compiler can only guess the reason of error and make modification according to the experience. Further, the interactive process of the directory menu should be executed once again after the modification, so as to verify whether the modified timing markup is correct or not.

### SUMMARY OF THE INVENTION

As embodied and broadly described herein, the present invention is directed to a method for examining a timing markup, which is used to increase the convenience of examining the timing markup by conducting an examination procedure on a graphic timing markup.

The present invention is further directed to a method of representing a timing markup, which converts the timing markup into a graphic timing markup of a tree structure, thereby making program compilers understand the content of the timing markup more easily.

The present invention is also directed to a computer-readable recording medium for recording a data structure of a timing markup, so as to record the content of the timing markup through the data structure of the tree structure.

The present invention provides a method of examining a timing markup, which includes the following steps. First, a timing markup is parsed, in which the timing markup includes at least one tag, and the tags include an execution tag, an action tag, or a combination thereof. Then, a graphic timing markup corresponding to the timing markup is generated according to the property of each tag and the relationship between the tags, in which the graphic timing markup includes nodes corresponding to the tags. Finally, the examination procedure of the timing markup is executed through the graphic timing markup.

In the method for examining a timing markup according to an embodiment of the present invention, the step of generating the graphic timing markup corresponding to the timing markup includes converting the execution tag into an execution node, and converting the action tag into an action node; connecting the execution node and the action node into a tree structure according to the position and sequence of each tag in the timing markup; and finally presenting the execution node and the action node in the tree structure with graphs, so as to generate the graphic timing markup.

In the method of examining a timing markup according to an embodiment of the present invention, the examination procedure includes displaying an execution path of executing the timing markup in the graphic timing markup.

In the method of examining a timing markup according to an embodiment of the present invention, the examination procedure includes selecting one node in the graphic timing markup as an interrupt point, then executing the timing markup and suspending the execution when the timing markup is executed to the tag corresponding to the interrupt point.

In the method of examining a timing markup according to an embodiment of the present invention, the execution procedure is suspended when the timing markup is executed to the tag corresponding to the interrupt point, and the execution path of executing the timing markup once again is displayed in the graphic timing markup.

In the method of examining a timing markup according to an embodiment of the present invention, the examination procedure includes displaying the content of the tag corresponding to each node in the graphic timing markup.

In the method of examining a timing markup according to an embodiment of the present invention, the examination procedure includes displaying path information of each node in the graphic timing markup. The path information includes all nodes from the root node to each node of the graphic timing markup.

In the method of examining a timing markup according to an embodiment of the present invention, the examination procedure includes setting an expected execution path in the graphic timing markup; executing the timing markup, and determining whether an actual execution path is identical to the expected execution path of the timing markup; and emitting an error warning when the actual execution path is different from the expected execution path.

In the method of examining a timing markup according to an embodiment of the present invention, the examination procedure includes establishing a new node on the graphic timing markup, and adding a new corresponding tag in the timing markup automatically according to the position and property of the new node in the graphic timing markup.

In the method of examining a timing markup according to an embodiment of the present invention, the new node is obtained by copying the original node, and the content of the new tag is obtained by copying or modifying the content of the original node in the timing markup.

In the method of examining a timing markup according to an embodiment of the present invention, the timing markup is a timing markup of an interactive high definition (HDi) directory menu.

From another aspect, the present invention provides a method of presenting a timing markup, which includes the following steps. First, a timing markup is provided, in which the timing markup includes at least one tag, and the tags include an execution tag, an action tag, or a combination thereof. Next, each execution tag is converted into an execution node, and each action tag is converted into an action node. Then, the execution node and the action node are connected correspondingly according to the relationship between the execution tag and the action tag in the timing markup, so as to form a tree structure. Finally, the execution nodes and the action nodes in the tree structure are presented with graphs, so as to generate a graphic timing markup.

In the method for presenting a timing markup according to an embodiment of the present invention, the relationship includes the positions and sequences of the execution tags and the action tags in the timing markup.

In the method for presenting a timing markup according to an embodiment of the present invention, the execution tag includes a parallel execution tag or a serial execution tag.

In the method for presenting a timing markup according to an embodiment of the present invention, the step of converting each execution tag into an execution node and converting each action tag into an action node includes converting the parallel execution tag into a parallel execution node and converting the serial execution tag into a serial execution node.

In the method for presenting a timing markup according to an embodiment of the present invention, if the execution tag includes other tags, the execution nodes or action nodes corresponding to the tags are connected to the execution node corresponding to the execution tag.

The method for presenting a timing markup according to an embodiment of the present invention further includes displaying the content of the tag corresponding to the execution node or the action node.

The method for presenting a timing markup according to an embodiment of the present invention further includes displaying path information of the execution node or the action node, and the path information includes all nodes from the root node to the execution node or the action node of the graphic timing markup.

In the method of presenting a timing markup according to an embodiment of the present invention, the timing markup is a timing markup of an HDi directory menu.

From another aspect, the present invention provides a computer-readable recording medium for recording a data structure of a timing markup, which is used for establishing a graphic timing markup corresponding to the timing markup, where the graphic timing markup includes a root node and at least one sub-node. The root node is used for displaying a title of the timing markup, and each sub-node is an execution node or an action node, the execution node is corresponding to the execution tag in the timing markup, and the action node is corresponding to the action tag in the timing markup. The root node and sub-nodes are connected with one another to form a tree structure according to the position and sequence of the corresponding execution tag or action tag in the timing markup.

In the computer-readable recording medium for recording a data structure of a timing markup according to an embodiment of the present invention, the tag content information includes the content of the execution tag or the action tag corresponding to each sub-node.

In the computer-readable recording medium for recording a data structure of a timing markup according to an embodiment of the present invention, the tag content information includes path information of each sub-node, the path information includes all nodes from the root node to the sub-node.

In the computer-readable recording medium for recording a data structure of a timing markup according to an embodiment of the present invention, the execution node includes a parallel execution node and a serial execution node. The parallel execution node is corresponding to the parallel execution tag in the timing markup, and the serial execution node is corresponding to the serial execution tag in the timing markup.

In the computer-readable recording medium for recording a data structure of a timing markup according to an embodiment of the present invention, the serial execution node includes more than one action node, and the relative position of the action node in the graphic timing markup indicates the sequence of executing the action nodes when executing the timing markup.

The present invention adopts a graphic timing markup of a tree structure to present the content of the timing markup, and executes several examination procedures on the graphic timing markup, such that the efficiency of examining the timing markup is improved, and the convenience of understanding and modifying the timing markup is also increased.

In order to make the aforementioned and other objectives, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method for presenting a timing markup according to an embodiment of the present invention.

FIG. 2 is a schematic view of a timing markup according to an embodiment of the present invention.

FIG. 3 is a schematic view of a graphic timing markup according to an embodiment of the present invention.

FIG. 4 is a schematic view of a graphic timing markup according to another embodiment of the present invention.

FIG. 5 is a schematic view of a graphic timing markup according to still another embodiment of the present invention.

FIG. 6 is a flow chart of a method for examining a timing markup according to an embodiment of the present invention.

FIG. 7 is a schematic view of a graphic timing markup according to an embodiment of the present invention.

FIG. 8 is a schematic view of a graphic timing markup according to another embodiment of the present invention.

FIG. 9 is a schematic view of a graphic timing markup according to still another embodiment of the present invention.

### DESCRIPTION OF EMBODIMENTS

When compiling a timing markup or using a time markup compiled by others, if a simple graph is used to indicate each tag in the timing markup, and the graphs are connected according to the relationship between the tags so as to show the whole architecture of the timing markup, the compiler of the timing markup can understand the content of the timing markup more quickly, and examine whether the timing markup is correct or not conveniently, so as to increase the convenience in compiling the timing markup. In view of the above, the present invention provides a method for examining and presenting a timing markup. In order to make the aforementioned and other objectives, features and advantages of the present invention more comprehensible, preferred embodiments accompanied with figures are described in detail below.

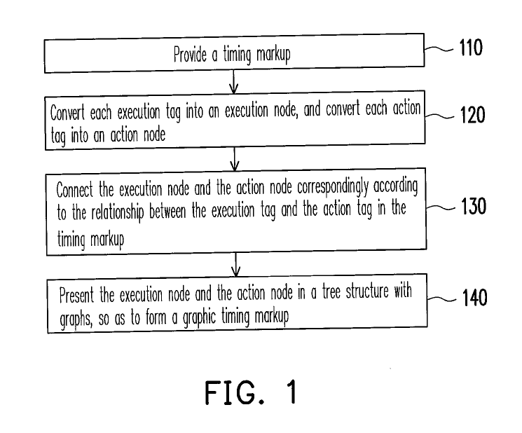

FIG. 1 is a flow chart of a method for presenting a timing markup according to an embodiment of the present invention. This embodiment is given for illustrating the detailed steps of presenting the timing markup by using a graphic timing markup. The timing markup is, for example, but not limited to, a timing markup of an interactive high definition (HDi) directory menu. Referring to FIG. 1, firstly shown in Step 110, a timing markup is provided. The timing markup includes at least one tag, and the tags may be an execution tag, an action tag, or a combination thereof. The execution tag includes a parallel execution tag and a serial execution tag.

Then, in Step 120, each execution tag in the timing markup is converted into an execution node, and each action tag is converted into an action node. If being a parallel execution tag, the execution tag is converted into a parallel execution node; if being a serial execution tag, the execution tag is converted into a serial execution node. The difference between the parallel execution tag and the serial execution tag lies in that: when the timing markup is executed, the actions of the action tags included in the parallel execution tag are conducted at the same time, and the actions of the action tags included in the serial execution tag are executed sequentially.

Then, in Step 130, according to the relationship between the execution tag and the action tag in the timing markup, the execution node and the action node are connected correspondingly, so as to form a tree structure. The relationship includes the position and sequence of each execution tag and each action tag in the timing markup. It should be noted that, if the execution tag includes other tags, the execution node or the action node corresponding to the above tag is connected to the execution node corresponding to the execution tag.

Finally in Step 140, all the execution nodes and action nodes in the tree structure are presented with graphs, so as to form a graphic timing markup corresponding to the timing markup.

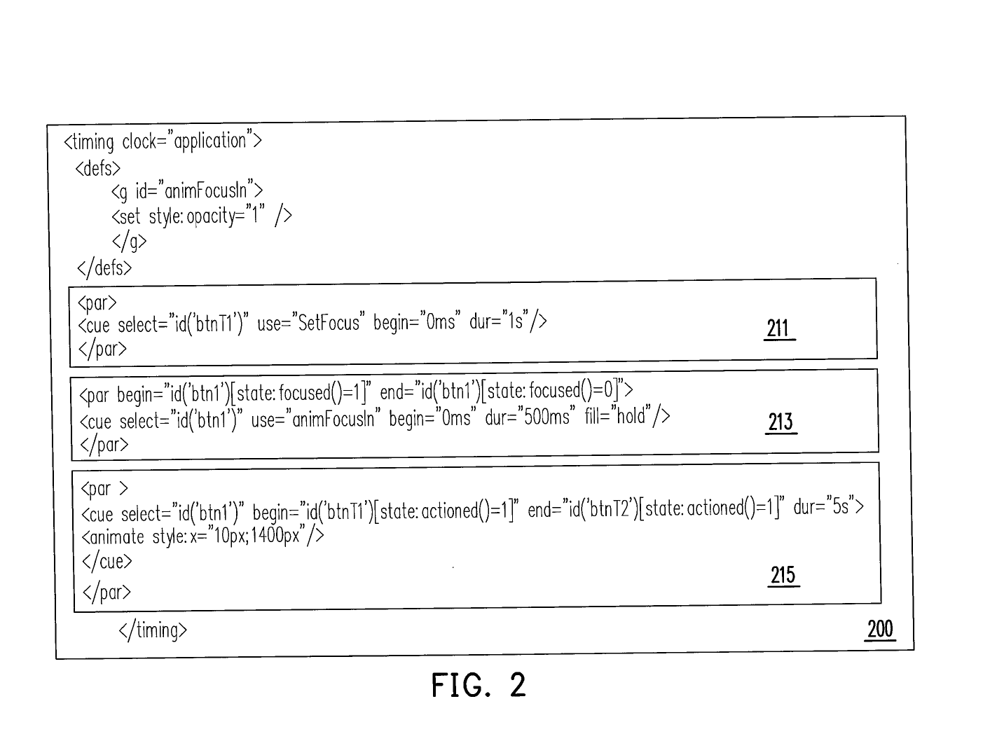

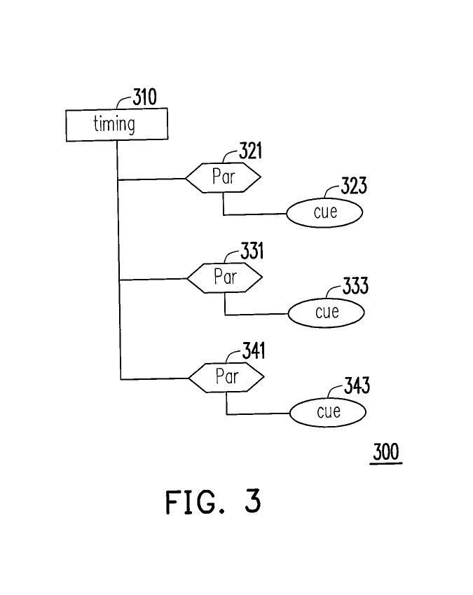

As far as a timing markup 200 shown in FIG. 2 is concerned, through the above steps in FIG. 1, the timing markup 200 is converted into a graphic timing markup 300 shown in FIG. 3. In a program code block 211, a parallel execution tag (i.e., a program code segment <par>) is converted into a parallel execution node 321, and an action tag (i.e., a program code segment <cue select=“id(‘btnT1’)” use=“SetFocus” begin=“0ms” dur=“1s”/>) is converted into an action node 323. In a program code block 213, a parallel execution tag (i.e., a program code segment <par begin=“id(‘btn1’) [state:focused( )=1]”end=“id(‘btn1’)[state:focused( )=0]”>) is converted into a parallel execution node 331, and an action tag (i.e., a program code segment <cue select=“id(‘btn1’)” use=“animFocusIn” begin=“0ms” dur=“500ms” fill=“hold”/>) is converted into an action node 333. Likewise, in the program code block 215, a parallel execution tag (a program code segment <par>) and an action tag (the program code segment <cue select=“id(‘btn1’)”begin—“id(‘btnT1’)[state:actioned( )=1]”end=“id(‘btnT2’)[state:actioned( )=1]” dur=“5s”>) are also respectively converted into a parallel execution node 341 and an action node 343.

In an embodiment, an execution path when executing the timing markup is displayed on the graphic timing markup. That is to say, during the execution of the timing markup, all nodes from the root node to the execution node or the action node being executed currently are all specially marked and connected, thereby displaying the execution path of the timing markup definitely.

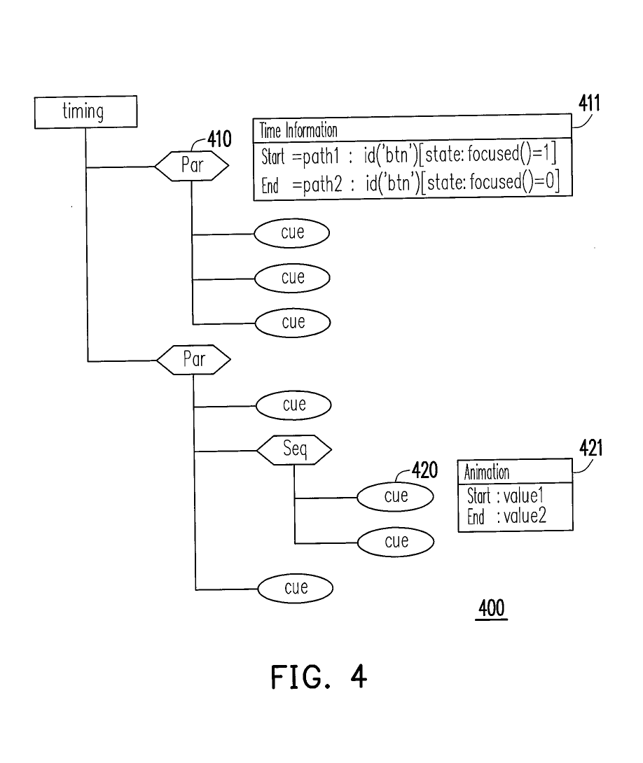

In another embodiment, the graphic timing markup can also display the content of the tag corresponding to the execution node or the action node. For example, in a graphic timing markup 400 of FIG. 4, the tag content 421 records animation information of the tag corresponding to the action node 420. The tag content 411 records time information of the tag corresponding to the parallel execution node 410. “Start=path1:id(‘btn’)[state:focused( )=1]” indicates a time reference for starting executing a corresponding tag, and “End=path2:id(‘btn’)[state:focused( )=0]” indicates a time reference for ending executing a tag corresponding to the parallel execution node 410. In another embodiment, the format of the time information of the tag content 411 is also indicated by a time. For example, “Start=time 1:0s” displayed in the tag content 411 indicates that the tag is executed since 0 second, and 1 s indicates that the tag is executed since 1 second, and the rest may be deduced by analogy. It should be noted that, different formats of the time information can be displayed matching with each other, for example, “Start=path1:id(‘btn’)[state:focused( )=1]” matches with “End=time 1:1s”; or “Start=time 1:0s” matches with “End=path2:id(‘btn’)[state:focused( )=0]”, but is not limited to the scope.

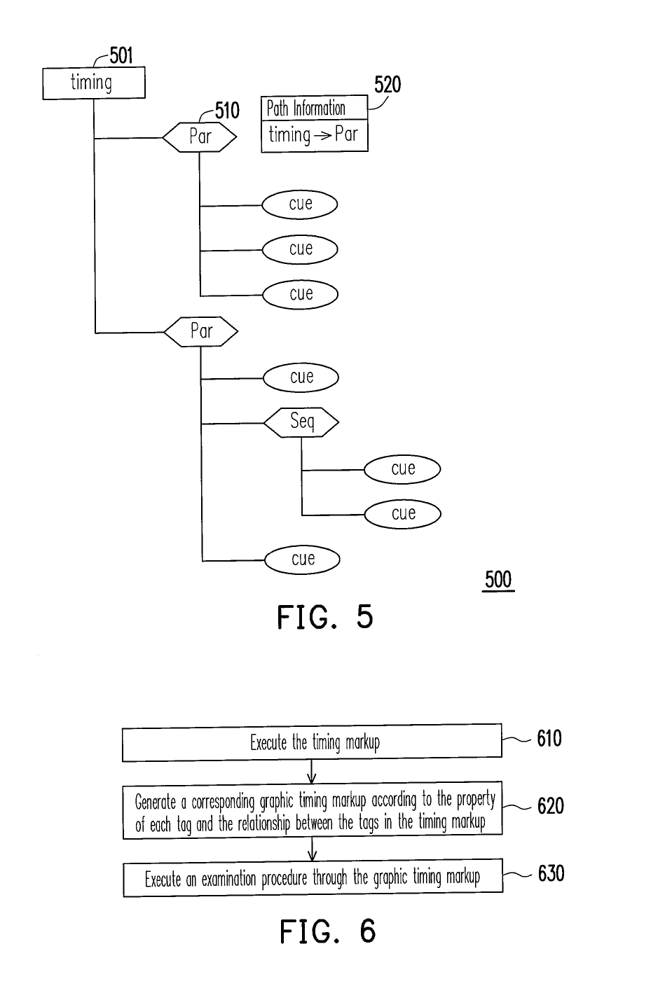

In another embodiment, the graphic timing markup is also used to display path information of the execution node or the action node. The path information includes all nodes from the root node to the execution node or the action node of the graphic timing markup. As far as a graphic timing markup 500 shown in FIG. 5 is concerned, the program compiler can know all the nodes from the root node 510 to the parallel execution node 510 according to the content recorded in the path information 520.

Besides, the graphic timing markup can further display a plurality of time information (e.g., the time information 411 shown in FIG. 4) and a plurality of path information (e.g., the path information 520 shown in FIG. 5). As far as the graphic timing markup 400 is concerned, in another embodiment, the path information (not shown) corresponding to the execution node 410 and the time information (not shown) corresponding to the action node 420 are displayed at the same time.

After the graphic timing markup for presenting the timing markup is established through the steps shown in FIG. 1, how to use the graphic timing markup to examine the timing markup is illustrated in the embodiments hereinafter, so as to further illustrate the present invention.

FIG. 6 is a flow chart of a method for examining a timing markup according to an embodiment of the present invention. Referring to FIG. 6, firstly shown in Step 610, a timing markup is parsed. In this embodiment, the timing markup is, for example, a timing markup of an HDi directory menu including at least one tag, and the tags are, for example, an execution tag, an action tag, or a combination of the execution tag and the action tag.

Then, as shown in Step 620, according to the property of each tag and the relationship between the tags in the timing markup, a graphic timing markup corresponding to the timing markup is generated. The graphic timing markup includes a plurality of nodes corresponding to the above tags. In this embodiment, the steps for generating the graphic timing markup corresponding to the timing markup are similar to those of the above embodiment, thus will not be repeated herein.

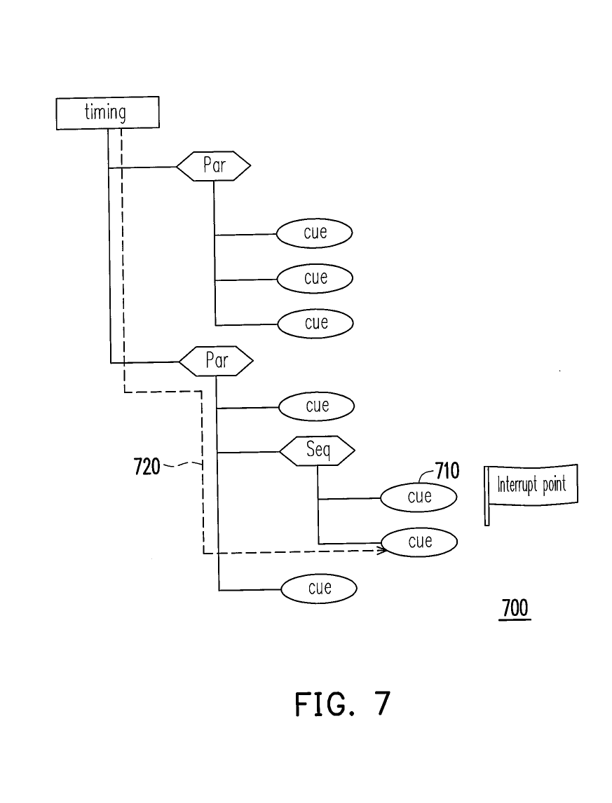

Finally in Step 630, an examination procedure of the timing markup is executed through the graphic timing markup. In an embodiment, the program compiler can know the execution path of executing the timing markup through the graphic timing markup. Besides, the program compiler can also select a node in the graphic timing markup as an interrupt point, and the execution is suspended when the timing markup is executed to the tag corresponding to the interrupt point. As far as a graphic timing markup 700 shown in FIG. 7 is concerned, if the program compiler selects an action node 710 as the interrupt point, the execution is suspended when the timing markup is executed to the tag corresponding to the action node 710. Meanwhile, the content (not shown) of the tag corresponding to the interrupt point is, for example, displayed on the graphic timing markup 700; otherwise, when the program compiler selects to execute the timing markup once again, the execution path of the next execution (e.g., the execution path 720) is displayed.

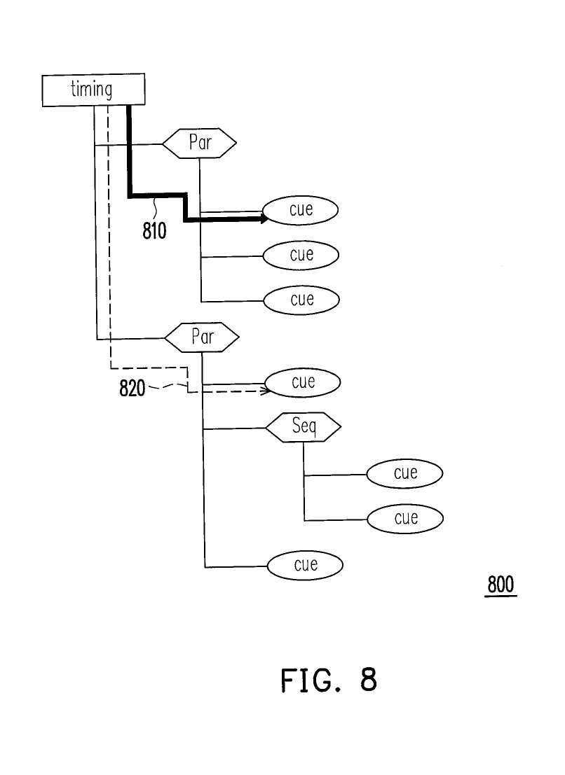

Referring to FIG. 8, when the program compiler intends to detect errors on logicality on the specific content in the timing markup, an expected execution path (e.g., an expected execution path 810) of executing the timing markup is set in the graphic timing markup 800. Then, during the execution of the timing markup, whether the actual execution path (e.g., an actual execution path 820) is identical to the expected execution path 810 or not is determined, so as to confirm the correctness of the timing markup. However, when the actual execution path is different from the expected execution path, an error warning is emitted to warn the program compiler that an error on logicality may occur on the timing markup.

Besides, the program compiler may also examine the content of the tag corresponding to each node and whether the path information of each node is correct or not through the graphic timing markup. The path information includes all nodes from the root node to each node of the graphic timing markup.

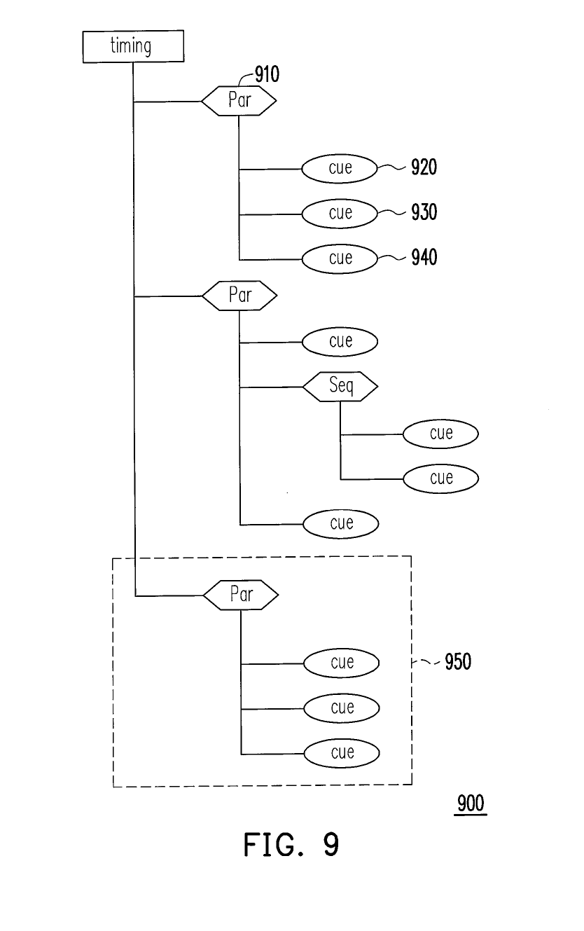

In another embodiment, the program compiler establishes one or more new node(s) on the graphic timing markup, which is (are), for example, established by copying the original node(s). After a new node is established, a corresponding new tag is added in the timing markup automatically according to the position and property of the new node in the graphic timing markup. Furthermore, the content of the new tag is, for example, obtained by copying the content of the original node in the timing markup, or by copying and modifying the content of the original node in the timing markup. As far as a graphic timing markup 900 shown in FIG. 9 is concerned, if a portion 950 framed by a dotted line is a new node generated by the program compiler through copying a parallel execution node 910, an action node 920, an action node 930, and an action node 940, the contents of the tag corresponding to the parallel execution node 910, the action node 920, the action node 930, and the action node 940 are automatically added in the timing markup corresponding to the graphic timing markup 900. If the program compiler modifies the tag content information of the parallel execution node 910, the action node 920, the action node 930, and the action node 940, the tag content corresponding to the above modification is also recorded in the timing markup.

It should be noted that, the graphic timing markup in the above embodiment is recorded in a data structure and stored in a computer-readable recording medium. The graphic timing markup recorded in the data structure includes a root node and at least one sub-node. The root node is used to display a title of the timing markup, and each sub-node is an execution node corresponding to an execution tag of the timing markup, or an action node corresponding to an action tag of the timing markup. The root node and the sub-nodes are connected with one another to form a tree structure according to the position and sequence of the corresponding execution tag or action tag in the timing markup.

In this embodiment, the data structure recording each sub-node also records tag content information corresponding to the sub-node. The tag content information includes the content of the execution tag or the action tag corresponding to the sub-node, and the path information of the sub-node (all nodes from the root node to the sub-node).

In another embodiment, the sub-node corresponding to the execution tag may be a parallel execution node or a serial execution node. The parallel execution node is corresponding to the parallel execution tag in the timing markup, and the serial execution node is corresponding to the serial execution tag in the timing markup. The position of the action node included in each serial execution node in the graphic timing markup is used to present the sequence of executing the above action nodes when executing the timing markup.

Based on the above, the methods of examining and presenting the timing markup and the data structure thereof according to the present invention at least have the following advantages.

1. A graphic timing markup of a tree structure is used to present the timing markup, such that the convenience of examining the timing markup is increased, and the content of the timing markup becomes easier to be understood.

2. An examination procedure is performed on the graphic timing markup, so as to improve the efficiency of examining and verifying the correctness of the timing markup by the timing markup compiler or playback program compiler.

3. The relevant information during the execution of the timing markup is displayed through the graphic timing markup, such that the error occurred during the execution can be definitely displayed through the graphic timing markup, and the program compiler can make an adjustment or modification quickly on the error.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for examining a timing markup, comprising:
executing a timing markup, wherein the timing markup comprises at least one tag, and the tags comprise one of an execution tag and an action tag or a combination thereof.
generating a graphic timing markup corresponding to the timing markup according to the property of the tags and the relationship between the tags, wherein the graphic timing markup comprises a plurality of nodes corresponding to the tags; and
executing an examination procedure of the timing markup through the graphic timing markup.

2. The method for examining a timing markup as claimed in claim 1, wherein the step of generating the graphic timing markup of the timing markup comprises:
converting the execution tag into an execution node, and converting the action tag into an action node;
connecting the execution nodes and the action nodes into a tree structure according to the position and sequence of each of the tags in the timing markup; and
presenting the execution nodes and the action nodes in the tree structure with graphs, so as to generate the graphic timing markup.

3. The method for examining a timing markup as claimed in claim 1, wherein the examination procedure comprises:
displaying an execution path when executing the timing markup in the graphic timing markup.

4. The method for examining a timing markup as claimed in claim 1, wherein the examination procedure comprises:
selecting one of the nodes in the graphic timing markup as an interrupt point;
executing the timing markup; and
suspending the execution when the timing markup is executed to the tag corresponding to the interrupt point.

5. The method for examining a timing markup as claimed in claim 1, wherein the examination procedure comprises:
displaying the content of the tag corresponding to each of the nodes in the graphic timing markup; and
displaying path information of each of the nodes in the graphic timing markup, wherein the path information comprises all nodes from a root node to the node of the graphic timing markup.

6. The method for examining a timing markup as claimed in claim 1, wherein the examination procedure comprises:
setting an expected execution path in the graphic timing markup;
executing the timing markup, and determining whether an actual execution path of the timing markup is identical to the expected execution path; and
emitting an error warning when the actual execution path is different from the expected execution path.

7. The method for examining a timing markup as claimed in claim 1, wherein the examination procedure comprises:
establishing a new node on the graphic timing markup; and
automatically adding a new corresponding tag in the timing markup according to the position and property of the new node in the graphic timing markup.

8. The method for examining a timing markup as claimed in claim 7, wherein the new node is obtained by copying an original node.

9. The method for examining a timing markup as claimed in claim 8, wherein the content of the new tag is obtained by copying and modifying the content of the original node in the timing markup.

10. The method of examining a timing markup as claimed in claim 1, wherein the timing markup is a timing markup of an interactive high definition (HDi) directory menu.

11. A method for presenting a timing markup, comprising:
providing a timing markup, wherein the timing markup comprises at least one tag, and the tags comprise one of an execution tag and an action tag or a combination thereof converting each of the execution tags into an execution node, and converting each of the action tags into an action node;
connecting the execution nodes and the action nodes correspondingly according to the relationship between the execution tags and the action tags in the timing markup, so as to form a tree structure; and
presenting the execution nodes and the action nodes in the tree structure with graphs, so as to generate a graphic timing markup.

12. The method for presenting a timing markup as claimed in claim 11, wherein the relationship comprises the positions and sequences of the execution tags and the action tags in the timing markup.

13. The method for presenting a timing markup as claimed in claim 11, wherein the execution tag comprises one of a parallel execution tag and a serial execution tag.

14. The method for presenting a timing markup as claimed in claim 13, wherein the step of converting each of the execution tags into the execution node and converting each of the action tags into the action node comprises:
converting the parallel execution tag into a parallel execution node; and
converting the serial execution tag into a serial execution node.

15. The method for presenting a timing markup as claimed in claim 11, wherein if the execution tag comprises other tags, the execution node or the action node corresponding to the tags is connected to the execution node corresponding to the execution tag.

16. The method for presenting a timing markup as claimed in claim 11, further comprising:
displaying the content of the tags corresponding to the execution nodes or the action nodes.

17. The method for presenting a timing markup as claimed in claim 11, further comprising:
displaying path information of the execution nodes or the action nodes, wherein the path information comprises all nodes from a root node to the execution node or the action node of the graphic timing markup.

18. The method for presenting a timing markup as claimed in claim 11, further comprising:
displaying an execution path of executing the timing markup in the graphic timing markup.

19. The method of presenting a timing markup as claimed in claim 11, wherein the timing markup is a timing markup of an HDi directory menu.

20. A computer-readable recording medium for recording a data structure of a timing markup, applicable for establishing a graphic timing markup corresponding to a timing markup, wherein the graphic timing markup comprises:
a root node, for displaying a title of the timing markup; and
at least one sub-node, wherein each of the sub-nodes is one of an execution node and an action node, the execution node is corresponding to an execution tag in the timing markup, and the action node is corresponding to an action tag in the timing markup,
wherein, the root node and the sub-nodes are connected with one another to form a tree structure according to the position and sequence of the corresponding execution tag or the corresponding action tag in the timing markup.

21. The computer-readable recording medium for recording a data structure of a menu as claimed in claim 20, wherein each of the sub-nodes records corresponding tag content information.

22. The computer-readable recording medium for recording a data structure of a menu as claimed in claim 21, wherein the tag content information comprises content of the execution tag or the action tag corresponding to each of the sub-nodes.

23. The computer-readable recording medium for recording a data structure of a menu as claimed in claim 21, the tag content information comprises path information of each of the sub-nodes, and the path information comprises all nodes from the root node to the sub-node.

24. The computer-readable recording medium for recording a data structure of a menu as claimed in claim 20, wherein the execution nodes comprise one of a parallel execution node and a serial execution node, the parallel execution node is corresponding to a parallel execution tag in the timing markup, and the serial execution node is corresponding to a serial execution tag in the timing markup.

25. The computer-readable recording medium for recording a data structure of a menu as claimed in claim 24, wherein the position of the action nodes comprised in the serial execution node in the graphic timing markup indicates an execution sequence of the action nodes when executing the timing markup.
